(19) United States
(12) Patent Application Publication
(10) Pub. No.: US 2016/0289416 A1
(43) Pub. Date: Oct. 6, 2016

(54) HOT-VULCANISABLE POLYORGANOSILOXANE COMPOSITIONS FOR USE IN PARTICULAR FOR THE PRODUCTION OF ELECTRICAL WIRES OR CABLES

(71) Applicant: BLUESTAR SILICONES FRANCE SAS, LYON (FR)

(72) Inventors: Gerald GUICHARD, Givors (FR); Amandine LOPEZ, Saint Symphorien d'Ozon (FR); David MARIOT, Lyon (FR)

(21) Appl. No.: 14/392,155

(22) PCT Filed: Jun. 24, 2014
(86) PCT No.: PCT/FR2014/000141

§ 371 Date: Dec. 23, 2015

(30) Foreign Application Priority Data
Jun. 27, 2013 (FR) 13/01512

(51) Int. Cl. C08K 3/26; C08K 3/08; H01B 13/06; C08K 5/098; H01B 3/44; H01B 7/295; C08L 83/04; C08K 3/36

(52) U.S. Cl. CPC C08K 3/26; C08L 83/04; C08K 3/08; C08K 3/36; C08K 5/098; H01B 3/441; H01B 7/295; H01B 13/06; C08L 2201/08; C08L 2203/202; C08L 2201/02; C08K 2003/265; C08L 2205/025; C08L 2207/04

(57) ABSTRACT

The present invention concerns novel polyorganosiloxane compositions that can be hot-vulcanised into silicone elastomers, i.e. that can be vulcanised at temperatures generally in the region of between 100° and 200° C. and, if necessary, up to 250° C. The invention also concerns the use of these compositions for the production of casings or primary insulators used to form electrical wires or cables protected against fire. The invention finally concerns the electrical wires or cables protected against fire that are produced using said compositions.

The present invention relates to polyorganosiloxane compositions that can be hot-vulcanized into silicone elastomers, i.e. are vulcanizable at temperatures of the material generally between 100° C. and 200° C. and that may be up to 250° C. if necessary. The invention further relates to the use of these compositions notably for making the coverings or primary insulation for electric wires or cables protected against fire. The invention finally relates to the electric wires or cables protected against fire that are manufactured with the use of identical compositions.

“Electric wire” means an electrical engineering component for conveying electricity, in order to transmit energy or information, and which consists of a material that conducts electricity, single-core or multicore, surrounded by an insulating covering. The interior of an electric wire is called the “core” of the wire.

“Conductor” or “single conductor” means an element made up of a core and its insulating covering.

“Electric cable” means an electrical engineering component for conveying electricity, in order to transmit energy or information, and which consists of several conductors that are electrically separate and mechanically integral, optionally with external screening.

An electric cable consists of one or more single conductor(s) (generally based on copper or aluminum); each of these single conductors is protected by a covering or primary insulation made of one or more concentric layer(s) based on an insulator. Around this covering or these coverings (in the case of a cable with several individual conductors), one or more filling element(s) and/or one or more reinforcing element(s) is/are provided, notably based on glass fibers and/or mineral fibers. Then an outer sheath, which may comprise one or more sheath(s), is most often present. In the case of an electric cable with several single conductors, the filling element or elements and/or the reinforcing element or elements, which is (are) arranged around the single conductors (each provided with its primary insulation), constitute(s) a common covering for all the single conductors.

The expressions “electric wires or cables protected against fire” or “fire-resistant safety electric wires or cables” define electric wires or cables that must guarantee behavior in fire of high quality in terms at least of cohesion of the ash and flame resistance. The characteristics that the electric wires or cables protected against fire must possess are covered by legal regulations in many countries, and rigorous standards have been established.

The present invention applies typically, but not exclusively, to the field of “electric wires or cables protected against fire”, i.e. fire-resistant and capable of functioning for a specified length of time in conditions of a fire, without being a fire propagator or a substantial smoke generator. These electric wires or cables protected against fire are in particular electric wires or cables for conveying power or for low-frequency transmission. One of the major challenges of the cable industry is improvement of the behavior and performance of cables in extreme thermal conditions, notably those encountered in a fire. In fact, when the materials constituting the insulating sheaths have inadequate performance, the overheating of the conducting wires comprised in an electric wire or cable leads to the formation of electric arcs or of short circuits, which may lead to ignition and combustion of the latter, thus spreading the fire.

Thus, for safety reasons, it is in fact essential to maximize the capacity of electric wire or electric cable to delay the propagation of flames on the one hand, and to withstand the fire on the other hand, in order to ensure continuity of operation, notably for devices that are vital for the safety of people, such as an alarm system, an elevator, a fixed telephone, to provide better conditions for intervention by the emergency services.

A fire-resistant safety electric wire or cable must moreover not be dangerous for its environment, i.e. must not release toxic and/or dense smoke when it is subjected to extreme thermal conditions.

A fire-resistant safety electric wire or cable must be prepared from materials having good cohesion of the residue after combustion in a fire, in order to ensure sufficient insulation of the metallic conductor, to prevent circuit failure. The required fire resistance and the stresses imposed are summarized in French standard NF C 32-070 CR1, which relates to the operating time of cables burning in defined conditions. Fire resistance is to be ascribed to the production of ash, which must display a certain cohesion so as to maintain sufficient insulation for operation of the cables. This test consists of submitting a test specimen of cable or wire to the thermal flux of an electric furnace heated to about 900° C., and checking its electrical operation during the test. The test specimen is in addition placed under tension, and submitted to mechanical shocks. A test is judged satisfactory if control lamps connected to the cables supplied at a nominal voltage are still alight at the end of the test.

The aforementioned standard can only be satisfied for electric wires or cables for which at least the primary insulating materials have been specially designed with respect to their nonpropagation of fire.

To ensure the integrity of the insulation of flexible electric wires or cables in a fire, the cable industry has used two technologies: fire-resistant mica tapes or silicone elastomers that are transformed to ceramic.

Robust but rigid, insulation based on mica tape is easy to use on an industrial scale, and it provides an insulating sheath that is effective and robust when it is covered with crosslinked polyethylene. The drawback is that the cables manufactured by this technique are rigid and much more difficult to strip and connect.

Silicone elastomer insulation is an effective alternative to mica tape. Its direct extrusion on the conductors leads to a good compromise between fire resistance and ease of laying. Moreover, in contrast to materials prepared from organic polymers, silicone materials exposed to high temperatures under oxygen lead to the formation of an ash substance based on silica, which has the advantage of being insulating. This intrinsic property of silicone materials favored their uses in the field of electric wires or cables. In fact, after combustion, it is the silica residue that maintains the function of insulation of the conducting wire while delaying volatilization of the decomposition products, reducing the amount of volatile substances available for combustion in the gas phase and therefore reducing the amount of heat available at the surface of the electric wire or cable. The silica residue can also insulate the surface of the conducting wire from the incident heat flux. However, this layer of silica obtained from a silicone material does not have sufficient cohesion, disintegrating at the slightest impact. Thus, in an electric wire or cable, just the properties of a protective layer of silicone material, even filled with silica, are not sufficient for this electric wire or cable to be qualified in the category of fire-resistant safety electric wires or cables according to French standard NF C 32-070 CR1.

To overcome this drawback, the prior art describes polyorganosiloxane compositions that can be hot-vulcanized into silicone elastomers comprising a polyorganosiloxane polymer that crosslinks by catalysis with peroxide, fillers of the flux type and/or of the lamellar type, which may or may not be combined with platinum and with metal oxides in order to give rise, in the case of a fire, to the formation of an insulating ash substance that has a certain cohesion, which makes it possible to prolong the operating time of the cables in a fire. We may mention document EP-A-0 467 800, which proposes the use both of zinc oxide or ZnO (as flux) and of mica (as lamellar filler), optionally combined with a platinum compound and/or metal oxides, for example titanium oxide and iron oxide.

Another technical solution is described in patent application WO 01/34696, in which polyorganosiloxane compositions that can be hot-vulcanized into silicone elastomers contain:
100 parts of an ingredient a) consisting of at least one polyorganosiloxane polymer,
5 to 80 parts of at least one reinforcing filler,
0.2 to 8 parts of an organic peroxide,
8 to 30 parts of mica,
6 to 20 parts of zinc oxide,
0 to 15 parts of at least one additive usually employed in the field of hot-vulcanizable polyorganosiloxane compositions,
   said compositions being characterized in that they additionally contain, as other obligatory ingredients:
0.0010 to 0.02 part of platinum, a platinum compound and/or a platinum complex,
2 to 10 parts of titanium oxide, and
50 to 120 parts of an ingredient i) consisting of at least one filler.

Other useful compositions are disclosed in patent application WO01/34705, which describes polyorganosiloxane compositions that can be hot-vulcanized into silicone elastomers having improved fire behavior, containing:

a) at least one polyorganosiloxane polymer;

b) at least one reinforcing filler;

c) an organic peroxide;

d) mica;

e) zinc oxide;

f) optionally at least one additive usually employed in the field of hot-vulcanizable polyorganosiloxane compositions;

said compositions being characterized in that they additionally contain, as other obligatory ingredients:

g) platinum, a platinum compound and/or a platinum complex;

h) titanium oxide;

i) at least one filler; and

j) at least one mineral species belonging to the wollastonite group.

Finally, patent application WO2004/064081 describes the use of polyorganosiloxane compositions that can be hot-vulcanized into silicone elastomers containing:

a) at least one polyorganosiloxane polymer;

b) at least one reinforcing filler;

c) an organic peroxide;

d) mica;

e) zinc oxide;

f) optionally at least one additive usually employed in the field of hot-vulcanizable polyorganosiloxane compositions;

g) platinum, a platinum compound and/or a platinum complex;

h) titanium oxide;

i) at least one filler; and

j) optionally at least one mineral species belonging to the wollastonite group,

said compositions being characterized in that the fillers i) consist of surface-treated powders of aluminum hydroxide Al(OH)₃.

Thus, the electric wires or cables of the prior art that have the benefit of the designation “safety” require the use of cables whose primary insulating materials have been specially designed with respect to their nonpropagation of fire. The primary insulating materials based on silicone elastomers are most often obtained from a polyorganosiloxane composition crosslinking either at high temperature under the action of organic peroxides, or crosslinking at room temperature or with heat by polyaddition reactions in the presence of a metal catalyst.

A ready-to-use mixture is a hot-vulcanizable composition of polyorganosiloxanes (HVE) that is a precursor of the silicone insulating material. An HVE composition generally comprises, in proportions that depend on the final properties required:
polyorganosiloxane oils and/or gums with siloxyl functions having vinyl-containing groups, preferably at chain end,
reinforcing fillers, in particular silicas from combustion;
optionally a plasticizer or an anti-structure agent (which slows down the development of viscosity during storage);
a hardening component in a sufficient amount for hardening the composition either at room temperature or under the action of heat, and
a thermal stabilizing system.

These mixtures are delivered in the form of one or more components and can be formulated directly by the user depending on the specific properties required. After plastication by kneading, these ready-to-use HVE mixtures are employed by extrusion, for metal wire or conductor cables. In fact, when making a covering or primary insulation of a single conductor, the ready-to-use HVE mixture is then deposited around each single conductor, then crosslinked to silicone elastomer by heating, providing a temperature of the material in the range from 100° C. to 250° C. The silicone material obtained is then described as “annealed”. The thicknesses of the insulators of silicone materials are small (not more than a few mm in thickness for certain cables). However, the properties of flame resistance are always required and are evaluated notably according to standard IEC60707 and more precisely by standard UL 94V, which is the standard applied by the “American Underwriters Laboratories” for testing the flammability and fire safety of silicone material insulation. Self-extinguishability is characterized by measuring the length of time that a test specimen is still burning after two successive applications of a Bunsen-burner flame. The smaller the thickness of the sample tested, the more demanding the test is for the material tested.

However, these ready-to-use HVE mixtures or polyorganosiloxane compositions that can be hot-vulcanized into silicone elastomers proposed to date are not completely satisfactory. In fact, these compositions have the disadvantage of displaying properties of stickiness, thus complicating their handling (or “their processability”) in industrial manufacture or when used by extrusion in the context of the production of electric wires or cables.

Another problem encountered with these compositions is connected with the requirements imposed for attaining a level of performance satisfying French standard NF C 32-070 CR1. In fact, the prior art teaches that it is necessary for the HVE compositions to contain a large amount of mineral particles so that the residue after degradation of the material still has sufficient integrity to continue to ensure good electrical operation. To have a real influence, the levels of inorganic fillers introduced in a ready-to-use HVE mixture are most often introduced in amounts above 50 wt % relative to the total weight of the mixture. This leads to high viscosity or consistency of these ready-to-use HVE mixtures, imposing high stresses on the industrial equipment notably in the extrusion step. The ease of use or “processability” is therefore an important criterion especially in the context of an industrial process. In fact, when they are employed in the manufacture of a conductor (consisting of a core and an insulating covering), the ready-to-use HVE mixtures are all kneaded first, so as to “plasticize the paste”, then they are extruded so as to arrange the insulating material around the conducting core and crosslinked by heating for final hardening of the insulating material.

Another problem connected with these high levels of fillers present in the matrix of the silicone material is an increase of the density of the material obtained and thus of the weight of the safety electric wires and cables. This is opposite to what the users demand, who require lighter and lighter safety electric wires or cables. Moreover, the mechanical properties, and notably the elongation at break, of these heavily filled silicone materials are impaired.

Another important additive for improving the fire behavior of a silicone material is platinum (Pt) or platinum derivatives. In fact, addition of platinum, preferably in the presence of silica, makes it possible to improve the thermal stability and the fire behavior of silicone material. It is now known that the presence of platinum and silica in a silicone material makes it possible to increase the level of silicone residue after combustion.

Although in absolute value a small amount of platinum is necessary, so as to be able to meet the extreme conditions according to French standard NF C 32-070 CR1 and according to the prior art, it is important to add:
56 ppm of platinum metal and more than 50 wt % of mineral fillers to the composition described in the example in patent application EP 1 238 007,
25 ppm of platinum metal and more than 50 wt % of mineral fillers to the composition described in the example in patent application EP 2 004 741, or
10 ppm of platinum metal and more than 50 wt % of mineral fillers to the composition described in the example in patent application EP 2 099 848.

The very high cost of platinum prompts the safety cables industry to find technical alternatives requiring less platinum in the silicone materials used for insulation of safety electric cables and wires without impairing the heat resistance properties of the silicone material and while complying with the standard.

Thus, the ready-to-use HVE mixtures or the hot-vulcanizable compositions of polyorganosiloxanes (HVE) that are precursors of a silicone insulating material for safety electric wires and cables proposed to date are not completely satisfactory and require improvements, notably in order to:
a) obtain ash that is cohesive, which in the case of fire will lead to longer operating times of the cables,
b) reduce the density of the silicone insulating material obtained from ready-to-use HVE mixtures so as to reduce the weight of the safety electric wires and cables, preferably to a density below 1.3,
c) ensure that the viscosity of the ready-to-use HVE mixture is low enough so that it can be handled easily and to allow good processability with the equipment employed in the manufacture of safety electric wires and cables,
d) reduce the level of platinum used for improving thermal stability to values below 10 ppm or even below 5 ppm, and
e) obtain good performance of self-extinguishability or of flame resistance of the elastomers obtained from ready-to-use mixtures according to the protocol defined by the reference “The Underwriters Laboratories” (UL 94V), fourth edition of 18 Jun. 1991.

One aim of the present invention is therefore to develop polyorganosiloxane compositions that can be hot-vulcanized into silicone elastomers that are already capable, when they are used just for making the primary insulation, of endowing the electric wires and cables with fire behavior of very high quality, characterized at least by the achievement of good cohesion of the ash to satisfy standard “NF C 32-070 CR1” and make improvements with respect to the required properties enumerated in points b) to e) above.

A composition C was found, and this constitutes the first object of the present invention, comprising:
(A) per 100 parts by weight of at least one polyorganosiloxane polymer A having per molecule at least two C₂-C₆ alkenyl groups bound to the silicon,
(B) from 0.1 to 250 parts by weight, preferably from 0.5 to 250 parts by weight and even more preferably from 1 to 200 parts by weight of at least one mineral B selected from the group consisting of: hydromagnesite of empirical formula Mg₅(CO₃)₄(OH)₂.4H₂O, huntite of empirical formula Mg₃Ca(CO₃)₄ and mixtures thereof,
(C) from 0 to 0.02 part by weight, or from 0 ppm to 200 ppm, and preferably from 0.00001 to 0.02 part by weight, or from 0.1 ppm to 200 ppm, expressed as weight of elemental platinum metal relative to the total weight of the composition C, of at least one thermal stabilizer D for improving the resistance of the silicone elastomers to degradation under the effect of temperatures above 800° C. and that is selected from the group consisting of: platinum metal, a platinum compound, a platinum complex and mixtures thereof, and
(D) a hardening component E in a sufficient amount for hardening the composition.

The composition C of polyorganosiloxane(s) that is hardenable to a silicone elastomer is particularly useful as insulation in an electric wire or cable.

Thus, the applicant discovered that the use of at least one mineral B selected from the group consisting of: hydromagnesite of empirical formula Mg₅(CO₃)₄(OH)₂.4H₂O, huntite of empirical formula Mg₃Ca(CO₃)₄ and mixtures thereof, in the composition according to the invention leads to a good compromise in the electric wires or cables application and makes it possible to:
obtain ash that is more cohesive, which will lead in the case of fire to longer operating times of the cables,
provide good extrudability and improved ease of use (or “processability”) of the composition relative to the compositions of the prior art and no longer display the deleterious properties of stickiness of the prior art, thus allowing easier handling, which is an important advantage for industrial implementation,
reduce the density of the silicone insulating material obtained from ready-to-use HVE mixtures so as to reduce the weight of the safety electric wires and cables and achieve low densities below 1.3,
reduce the level of platinum used for improving the thermal stability to values below 10 ppm or even below 5 ppm, and
obtain good performance of self-extinguishability or of flame resistance of the elastomers obtained from ready-to-use mixtures according to the protocol defined by the reference “The Underwriters Laboratories” (UL 94V), fourth edition of 18 Jun. 1991.

According to a preferred embodiment, the amount by weight of mineral B expressed per 100 parts by weight of the polyorganosiloxane polymer or polymers A is between 1 and 100 parts by weight, between 1 and 50 parts by weight, between 1 and 30 parts by weight or preferably between 3.5 and 30 parts by weight.

The hydromagnesite of empirical formula Mg₅(CO₃)₄(OH)₂.4H₂O is a mineral of lamellar structure for which the dimensions of the primary particle are of the order of 2 to 5 μm of diagonal D and for example of 200 nm of thickness d and of form factor 1:20.

Huntite, of empirical formula Mg₃Ca(CO₃)₄, is a mineral of lamellar structure for which the dimensions of the primary particle are of the order of 1 to 2 μm of diagonal D, for example 50 nm of thickness d and of form factor 1:20.

The Mohs hardness of hydromagnesite and of huntite is of the order of 1 to 2 and the aspect ratio is for example greater than or equal to 1:20. Hydromagnesite and huntite are generally in the form of aggregates of lamellar primary particles with a size generally between 1 and 15 μm with a thickness between 100 and 500 nm.

The thermal stabilizer D contains platinum, which may be in the form of: metallic (elemental) platinum, chloroplatinic acid (for example hexachloroplatinic acid H₂PtCl₆), hydrated chloroplatinic acid H₂PtCl₆.6H₂O (as described in patent U.S. Pat. No. 2,823,218), in the form of platinum complexes and organic products: such as notably the complexes of platinum and vinyl-containing organosiloxanes (for example the Karstedt complex cf. U.S. Pat. No. 3,775,452), the complexes such as those of formula (PtCl₂, olefin)₂ and H(PtCl₃, olefin) described in patent U.S. Pat. No. 3,159,601, where the olefin represents ethylene, propylene, butylene, cyclohexene or styrene, the complexes of platinum chloride and cyclopropane described in American patent U.S. Pat. No. 3,159,662 or complexes of the Pt-carbene type such as those described in patent application EP1866364-A1.

Another advantage of the composition according to the invention is that the amount of platinum used as thermal stabilizer D may be reduced to amounts below 10 ppm, 9 ppm or 5 ppm relative to the total weight of the composition.

Thus, according to an advantageous embodiment, the composition C is characterized in that it comprises from 0.00001 to 0.0009 part, or from 0.1 ppm to 9 ppm, expressed as weight of elemental platinum metal relative to the total weight of the composition C and of at least one thermal stabilizer D for improving the resistance of the silicone elastomers to degradation under the effect of temperatures above 800° C. and that is selected from the group consisting of: platinum metal, a platinum compound, a platinum complex and mixtures thereof.

According to a preferred embodiment, the invention therefore relates to a composition C comprising:
(A) per 100 parts by weight of at least one polyorganosiloxane polymer A having per molecule at least two C₂-C₆ alkenyl groups bound to the silicon,
(B) from 0.5 to 250 parts by weight of at least one mineral B selected from the group consisting of: hydromagnesite of empirical formula Mg₅(CO₃)₄(OH)₂.4H₂O, huntite of empirical formula Mg₃Ca(CO₃)₄ and mixtures thereof,
(C) from 0.00001 to 0.02 part by weight, or from 0.1 ppm to 200 ppm, expressed as weight of elemental platinum metal relative to the total weight of the composition C, of at least one thermal stabilizer D for improving the resistance of the silicone elastomers to degradation under the effect of temperatures above 800° C. and that is selected from the group consisting of: platinum metal, a platinum compound, a platinum complex and mixtures thereof,
(D) a hardening component E in a sufficient amount for hardening the composition,
(E) from 0 to 200 parts by weight, preferably from 0.5 to 120 parts by weight and even more preferably from 0.5 to 50 parts by weight of at least one fusible filler F having a softening point between 300′C and 900° C.,
(F) from 0 to 250 parts by weight and preferably from 0.1 to 100 parts by weight and even more preferably from 0.5 to 50 parts by weight of at least one refractory mineral filler G,
(G) from 0 to 300 parts by weight, preferably from 1 to 100 parts by weight and even more preferably from 1 to 80 parts by weight of at least one fireproofing mineral filler H selected from the group consisting of: magnesium hydroxide Mg(OH)₂, aluminum hydroxide Al(OH)₃, which has optionally been surface-treated with an organoalkoxysilane or an organosilazane, and mixtures thereof, and
(H) from 0 to 20 parts by weight, preferably from 0.1 to 15 parts by weight and even more preferably from 0.5 to 10 parts by weight of a zinc oxide.

The polyorganosiloxane polymer A may be linear or branched. By way of illustration, the polyorganosiloxane polymer A may consist of:
siloxyl units of general formula (I′): RₙSiO_{(4-n)/2}
and at least two siloxyl units of general formula (II′): ZₓR_{y}SiO_{(4-x-y)/2}
   and in said formulas the various symbols have the following meanings:
      the symbols R, which may be identical or different, each represent a group of a nonhydrolyzable hydrocarbon nature, and this radical may be:
         an alkyl radical having from 1 to 5 carbon atoms or haloalkyl having from 1 to 5 carbon atoms and comprising from 1 to 6 chlorine and/or fluorine atoms,
         a cycloalkyl and halocycloalkyl radical having from 3 to 8 carbon atoms and containing from 1 to 4 chlorine and/or fluorine atoms,
         an aryl, alkaryl or haloaryl radical having from 6 to 8 carbon atoms and containing from 1 to 4 chlorine and/or fluorine atoms, or
         a cyanoalkyl radical having from 3 to 4 carbon atoms;
   the symbols Z, which may be identical or different, each represent a C₂ to C₆ alkenyl group;
   n=an integer equal to 0, 1, 2 or 3;
   x=an integer equal to 1, 2 or 3 and preferably equal to 1,
   y=an integer equal to 0, 1, or 2; and
   the sum x+y=1, 2 or 3.

By way of illustration, we may mention, among the organic radicals R bound directly to the silicon atoms, the following radicals: methyl; ethyl; propyl; isopropyl; butyl; isobutyl; n-pentyl; t-butyl; chloromethyl; dichloromethyl; α-chloroethyl; α,β-dichloroethyl; fluoromethyl; difluoromethyl; α,β-difluoroethyl; trifluoro-3,3,3-propyl; trifluorocyclopropyl; trifluoro-4,4,4-butyl; hexafluoro-3,3,4,4,5,5-pentyl; δ-cyanoethyl; γ-cyanopropyl; phenyl: p-chlorophenyl; m-chlorophenyl; dichloro-3,5-phenyl; trichlorophenyl; tetrachlorophenyl; o-, p- or m-tolyl; α,α,α-trifluorotolyl; xylyls such as dimethyl-2,3-phenyl and dimethyl-3,4-phenyl.

Preferably, the organic radicals R bound to the silicon atoms are methyl, phenyl radicals, and these radicals may optionally be halogenated or may be cyanoalkyl radicals.

The symbols Z are alkenyls, which are preferably vinyl or allyl groups.

As concrete examples of siloxyl units of formula (I′), we may mention those of formulas: (CH₃)₂SiO_{2/2}, (CH₃)(C₆H₅)SiO_{2/2}, (C₆H₅)₂SiO_{2/2}, (CH₃)(C₂H₅)SiO_{2/2}, (CH₃CH₂CH₂—)(CH₃)SiO_{2/2}, (CH₃)₃SiO₁₂ and (CH₃)(C₆H₅)₂SiO_{1/2}.

As concrete examples of siloxyl units of formula (II′), we may mention those of formulas: (CH₃)(C₆H₅)(CH₂═CH)SiO_{1/2}, (CH₃)(CH₂═CH) SiO_{2/2} and (CH₃)₂(CH₂═CH)SiO_{1/2}.

As an example, the polyorganosiloxane polymer A may contain from 0.01 to 4 wt % of vinyl-containing group. When these polyorganosiloxane polymers A have viscosities at 25° C. between 1000 and 1 000 000 mPa·s, they are denoted by the term “oils”, but their viscosity may also be above 1 000 000 mPa·s and they are then denoted by the term “gums”. In the compositions according to the present invention, the polyorganosiloxane polymers may be oils or gums or mixtures. These oils and gums are marketed by silicone manufacturers or may be produced using techniques that are already known.

According to a preferred embodiment, the organosiloxane polymer A has, per molecule, at least 2 vinyl groups bound to different silicon atoms, situated in the chain, at chain ends or in the chain and at chain ends, and whose other organic radicals bound to the silicon atoms are selected from the group consisting of the radicals: methyl, ethyl and phenyl.

The thermal stabilizer D for improving the resistance of the silicone elastomers to degradation under the effect of temperatures above 800° C. is selected from the group consisting of: platinum metal, a platinum compound, a platinum complex and mixtures thereof. The platinum may be in the form of:
metallic (elemental) platinum,
chloroplatinic acid (for example hexachloroplatinic acid H₂PtCl₆),
platinum complexes and organic products such as notably the complexes of platinum and vinyl-containing organosiloxanes (for example the Karstedt complex), the complexes such as those of formula (PtCl₂, olefin)₂ and H(PtCl₃, olefin) where the olefin represents ethylene, propylene, butylene, cyclohexene or styrene, the complexes of platinum chloride and cyclopropane or the complexes of the platinum carbene type (such as those described for example in patent application EP1235836-A2).

The fusible filler F typically has a softening point between 300*C and 900° C. It may be selected from boron oxides (e.g. B₂O₃), anhydrous zinc borates (e.g. 2ZnO 3B₂O₃) or hydrated (e.g. 4ZnO B₂O₃ H₂O or 2ZnO 3B₂O₃3.5H₂O), and anhydrous boron phosphates (e.g. BPO₄) or hydrated, or a precursor thereof, which may be boron oxide or a calcium borosilicate, a recycled and ground glass based on aluminosilicate such as Fillite® 160W marketed by the company Omya, hollow or solid glass microspheres such as those in the Spheriglass® range (in particular Spheriglass® 7010 CP01, Spheriglass® 5000 CP01, Spheriglass® 2000 CP01 and Spheriglass® 3000 CP01) marketed by the company Potters Industries, the feldspars such as the products in the Microspar® range such as Microspar® 1351 600, Microspar® 1351 600MST sold by the company Quarzwerke, the hydrated calcium borates, or a mixture of these fillers.

The use of solid glass microspheres of the type Spheriglass® 7010 CP01 or Spheriglass® 5000 CP01 marketed by the company Potters Industries as fusible filler F is particularly preferred.

According to a preferred embodiment, the fusible filler F is selected from the group consisting of: boron oxide, zinc borates, boron phosphates, ground glasses, glasses in the form of beads, calcium borates and mixtures thereof.

The refractory mineral filler G may be at least one mineral filler selected from magnesium oxides (e.g. MgO), calcium oxides (e.g. CaO), silicon oxides (e.g. a precipitated or pyrogenic silica SiO₂, which is preferably surface-treated to render it hydrophobic by the techniques known in the field of silicones or a quartz), aluminum oxides or aluminas (e.g. Al₂O₃), chromium oxides (e.g. Cr₂O₃), titanium oxides, iron oxides, zirconium oxides (e.g. ZrO₂), nanoclays including 3 subclasses of the phyllosilicates, polysilicates and lamellar double hydroxides (montmorillonites, sepiolites, illites, attapulgites, talcs, kaolins, micas) and mixtures thereof.

According to a preferred embodiment, the refractory filler G is selected from the group consisting of: magnesium oxides, calcium oxides, silica, quartz, montmorillonites, talcs, kaolins, micas and mixtures thereof.

A combination of refractory fillers G is particularly preferred and consists of a combination of:
at least one refractory filler G1 selected from the group consisting of a silicon oxide (e.g. a precipitated or pyrogenic silica SiO₂, which is preferably surface-treated to render it hydrophobic by the techniques known in the field of silicones), a quartz, phyllosilicates such as for example the montmorillonites, sepiolites, illites, attapulgites, talcs, kaolins or micas (e.g. mica muscovite 6 SiO₂-3Al₂O₃—K₂O-2H₂O) and mixtures thereof, and
at least one refractory filler G2 selected from the group consisting of: magnesium oxides (e.g. MgO), calcium oxides (e.g. CaO), aluminum oxides or aluminas (e.g. Al₂O₃), chromium oxides (e.g. Cr₂O₃), zirconium oxides (e.g. ZrO₂) and mixtures thereof.

When said combination of refractory fillers G is used, the refractory fillers G1 are preferably present at a rate from 10 to 150 parts by weight per 100 parts by weight of polyorganosiloxane polymer A and the refractory fillers G2 are preferably present at a rate from 0.5 to 100 parts by weight per 100 parts by weight of polyorganosiloxane polymer A.

The silicon oxides such as silica have the advantage that they are widely used in the field of silicones as reinforcing fillers. They are generally selected from the silicas from combustion and the precipitated silicas. They have a specific surface area, measured by the BET methods, of at least 20 m²/g, preferably above 100 m²/g, and an average particle size below 0.1 micrometer (μm). These silicas may be incorporated preferably as they are or after being treated with organosilicon compounds usually employed for this use. These compounds include methylpolysiloxanes such as hexamethyldisiloxane, octamethylcyclotetrasiloxane, methylpolysilazanes such as hexamethyldisilazane, hexamethylcyclotrisilazane, chlorosilanes such as dimethyldichlorosilane, trimethylchlorosilane, methylvinyldichlorosilane, dimethylvinylchlorosilane, alkoxysilanes such as dimethyldimethoxysilane, dimethylvinylethoxysilane, trimethylmethoxysilane. During this treatment, the silicas may increase their starting weight by up to 20%, preferably about 10%.

The fireproofing mineral filler H is selected from the group consisting of: magnesium hydroxide Mg(OH)₂, aluminum hydroxide Al(OH)₃ that has optionally been surface-treated with an organoalkoxysilane or an organosilazane and mixtures thereof. Such a filler often has a particle size above 0.1 μm.

As concrete examples of organoalkoxysilanes, we may mention: methyltrimethoxysilane, methyltriethoxysilane, phenyltrimethoxysilane, ethyltrimethoxysilane, n-propyltrimethoxysilane, vinyltrimethoxysilane, vinyltri(2-methoxyethoxy)silane, vinyltriacetoxysilane, allyltrimethoxysilane, butenyltrimethoxysilane, hexenyltrimethoxysilane, gamma-methacryloxypropyltrimethoxysilane, dimethyldimethoxysilane, dimethyldiethoxysilane, diphenyldimethoxysilane, trimethylmethoxysilane, trimethylethoxysilane.

As concrete examples of organosilazane, we may mention: hexamethyldisilazane or divinyltetramethyldisilazane.

Preferably, the fireproofing mineral filler H is aluminum trihydroxide treated with an organoalkoxysilane.

The compositions according to the present invention may also further contain, as an optional ingredient, at least one mineral species I belonging to the wollastonite group. The wollastonite group comprises the following mineral species: calcium metasilicate (CaSiO₃) or wollastonite; the mixed metasilicate of calcium and sodium (NaCa₂HSi₃O₉) or pectolite; and the mixed metasilicate of calcium and manganese [CaMn(SiO₃)₂] or bustamite. Of course, it is possible to use a mixture of these various species. Preferably, the mineral species I is a wollastonite. Wollastonite exists in two forms: wollastonite itself, which chemists denote by α-CaSiO₃, which is commonly found in the natural state; and pseudo-wollastonite or β-CaSiO₃. More preferably, wollastonite α-CaSiO₃ is used. The mineral species I belonging to the wollastonite group need not be surface-treated or may be surface-treated with an organosilicon compound of the type mentioned above in connection with the aluminum hydroxide powder.

The mineral species I may be present at a rate from 2 to 20 parts by weight per 100 parts by weight of polyorganosiloxane A.

Thus, a preferred composition according to the invention comprises:
(A) per 100 parts by weight of at least one polyorganosiloxane polymer A having per molecule at least two C₂-C₆ alkenyl groups bound to the silicon,
(B) from 5 to 250 parts by weight of at least one mineral B selected from the group consisting of: hydromagnesite of empirical formula Mg₅(CO₃)₄(OH)₂.4H₂O, huntite of empirical formula Mg₃Ca(CO₃)₄ and mixtures thereof,
(C) from 0.0001 to 0.02 parts, or from 1 ppm to 200 ppm, expressed as weight of elemental platinum metal relative to the total weight of composition C, of at least one thermal stabilizer D for improving the resistance of the silicone elastomers to degradation under the effect of temperatures above 800° C. and that is selected from the group consisting of: platinum metal, a platinum compound, a platinum complex and mixtures thereof,
(D) a hardening component E in a sufficient amount for hardening the composition under the action of heat,
(E) from 0 to 200 parts by weight, preferably from 0.5 to 120 parts by weight and even more preferably from 0.5 to 50 parts by weight of at least one fusible ceramic filler F that has a softening point between 300′C and 900° C.,
(F) from 0 to 250 parts by weight and preferably from 0.1 to 100 parts by weight and even more preferably from 0.5 to 50 parts by weight of at least one refractory mineral filler G,
(G) from 0 to 300 parts by weight, preferably from 1 to 100 parts by weight and even more preferably from 1 to 80 parts by weight of at least one fireproofing mineral filler H selected from the group consisting of: magnesium hydroxide Mg(OH)₂, aluminum hydroxide Al(OH)₃, which has optionally been surface-treated with an organoalkoxysilane or an organosilazane, and mixtures thereof, and
(H) from 0 to 20 parts by weight of at least one mineral species I belonging to the wollastonite group.

According to a preferred embodiment, composition C is characterized in that the hardening component E is:
at least one organic peroxide (a-1), or
a component (a-2) consisting of:
   a) at least one polyorganosiloxane (II) having, per molecule, at least two hydrogen atoms bound to the silicon, and preferably at least three hydrogen atoms bound to the silicon, and
   b) an effective amount of at least one polyaddition catalyst (III) preferably selected from the group consisting of platinum, a platinum compound, a platinum complex and mixtures thereof.

When the hardening component E is an organic peroxide (a-1), composition C is hardenable at a high temperature (generally between 100 and 200° C.) under the action of organic peroxides. The polyorganosiloxane or gum included in such compositions called HVE then consists essentially of siloxyl units (V), optionally combined with units (VI) in which the residue Z represents a C₂-C₆ alkenyl group and where x is equal to 1. These HVEs are described for example in patents U.S. Pat. No. 3,142,655, 3,821,140, 3,836,489 and 3,839,266.

The polyorganosiloxane constituent of these HVE compositions advantageously has a viscosity at 25° C. at least equal to 300 000 mPa·s, and preferably between 1 million and 30 million mPa·s and even more.

The organic peroxide (a-1) may be any one of those that act as vulcanizing agents with respect to the silicone elastomer forming compositions. It may thus be any one of the peroxides or per-esters that are known to be used with silicone elastomers, for example ditert-butyl peroxide, benzoyl peroxide, tert-butyl peracetate, dicumyl peroxide, 2,5-diperbenzoate of 2,5-dimethylhexane and bis(t-butylperoxy)-2,5-dimethyl-2,5-hexane, monochlorobenzoyl peroxide, 2-4 dichlorobenzoyl peroxide, bis(2,4-dichlorobenzoyl) peroxide, tert-butyl peracetate, 2,5-dimethyl-2,5-di(tert-butylperoxy)hexane and 2,2-bis(t-butylperoxy)-p-diisopropylbenzene.

Preferably, the organic peroxide (a-1) is selected from the group consisting of 2,5-dimethyl-2,5-di(tert-butylperoxy)hexane or “Peroxide L”, dicumyl peroxide or “Peroxide D”, bis(2,4-dichlorobenzoyl) peroxide or “Peroxide E”, and mixtures thereof.

In general, when the organic peroxide (a-1) is present in the composition, from 0.05 to 10 parts by weight is added per 100 parts by weight of at least one polyorganosiloxane polymer A.

The composition according to the invention may also contain, as semi-reinforcing filler, at least one polyorganosiloxane resin (V) that preferably comprises at least one alkenyl residue in its structure. These polyorganosiloxane resins (V) are branched organopolysiloxane oligomers or polymers that are well known and commercially available. They may be in the form of formulations or solutions, preferably of siloxane. They have in their structure at least two different units selected from those of formula R₃SiO_{0.5} (unit M), R₂SiO (unit D), RSiO_{1.5} (unit T) and SiO₂ (unit Q), at least one of these units being a unit T or Q. The radicals R may be identical or different and are selected from the linear or branched C1-C6 alkyl radicals, the phenyl, trifluoro-3,3,3-propyl C2-C4 alkenyl radicals, and hydroxyl groups. We may mention for example: as alkyl radicals R, the methyl, ethyl, isopropyl, tert-butyl and n-hexyl radicals, and as alkenyl radicals R, the vinyl radicals. According to another particular embodiment, the polyorganosiloxane resin (V) comprises in its structure from 0.1 to 20 wt % of alkenyl group(s), said structure having siloxyl units of type M, which may be identical or different, siloxyl units of type(s) T, which may be identical or different, and/or Q and optionally siloxyl units of type D.

The composition according to the invention may also contain at least one thermal behavior additive J, for example iron octoate, cerium octoate or mixtures thereof.

During the manufacture of electric cables or wires by extrusion, the choice of peroxide will depend in practice on the method used for hardening the elastomer (method of vulcanization). When the method of vulcanization takes place in the absence of pressure (for example, hot-air furnace and/or radiation (infrared)), the peroxide used is then preferably monochlorobenzoyl peroxide and/or 2,4-dichlorobenzoyl peroxide. When the method of vulcanization takes place in the presence of pressure (for example, steam tube), the peroxide used is then preferably bis(t-butylperoxy)-2,5-dimethyl-2,5-hexane.

In the case of compositions C crosslinking by polyaddition reactions called RTV, the polyorganosiloxane polymer A bearing silylated alkenyl groups advantageously has a viscosity at 25° C. at most equal to 10 000 mPa·s, and preferably between 200 and 5000 mPa·s.

In the case of compositions C crosslinking by polyaddition reactions called LSR, the polyorganosiloxane polymer A bearing silylated alkenyl groups advantageously has a viscosity at 25° C. above 1000 mPa·s, preferably being in the range from a value above 5000 mPa·s to 200 000 mPa·s.

In the case of compositions C crosslinking by polyaddition reactions called polyaddition HVE, the polyorganosiloxane polymer A bearing silylated alkenyl groups advantageously has a viscosity at 25° C. above 300 000 mPa·s, and preferably between 1 million mPa·s and 30 million mPa·s or even higher.

In the cases of polyorganosiloxane compositions C called RTV, LSR or polyaddition HVE, component (a-2) will advantageously consist of:
a) at least one polyorganosiloxane (II) having, per molecule, at least two hydrogen atoms bound to the silicon, and preferably at least three hydrogen atoms bound to the silicon, and
b) an effective amount of at least one polyaddition catalyst (III), preferably selected from the group consisting of platinum, a platinum compound, a platinum complex and mixtures thereof.

As examples of polyorganosiloxane (II) we may mention those that comprise:
siloxyl units of formula (II-1):

$${H}_{d} {L}_{e} SiO \frac{4 - ( d + e )}{2} \qquad ( II \text{-} 1 )$$

in which:
   the groups L, which may be identical or different, each represent a monovalent hydrocarbon group having from 1 to 15 carbon atoms, for example an alkyl group having from 1 to 8 carbon atoms inclusive, optionally substituted with at least one halogen atom, selected advantageously from the methyl, ethyl, propyl and 3,3,3-trifluoropropyl groups, or an aryl group selected advantageously from a xylyl, tolyl or phenyl radical,
   d is an integer equal to 1 or 2, e is an integer equal to 0, 1 or 2, the sum d+e is equal to 1, 2 or 3, and
optionally siloxyl units of formula (II-2):

$${L}_{g} SiO \frac{4 - g}{2} \qquad ( II \text{-} 2 )$$

in which the groups L have the same meaning as above and g is equal to 0, 1, 2 or 3.

The dynamic viscosity at 25° C. of this polyorganosiloxane (II) is preferably at least equal to 10 mPa·s, and preferably it is between 20 and 10000 mPa·s. The polyorganosiloxane (II) may be formed solely of units of formula (II-1) or may additionally comprise units of formula (II-2). The polyorganosiloxane (II) may have a linear, branched, cyclic or network structure.

Examples of siloxyl units of formula (II-1) are: H(CH₃)₂SiO_{1/2}, HCH₃SiO_{2/2} and H(C₆H₅)SiO_{2/2}. Examples of siloxyl units of formula (II-2) are: (CH₃)₃SiO_{1/2}, (CH₃)₃SiO_{1/2}, (CH₃)₂SiO_{2/2} and (CH₃)(C₆H₅)SiO_{2/2}.

Useful examples of polyorganosiloxane (II) are linear compounds such as:

dimethylpolysiloxanes with hydrogenodimethylsilyl end groups,

copolymers with (dimethyl)(hydrogenomethyl)polysiloxane units with trimethylsilyl end groups,

copolymers with (dimethyl)(hydrogenomethyl)polysiloxane units with hydrogenodimethylsilyl end groups, and

hydrogenomethylpolysiloxanes with trimethylsilyl end groups,

The polyorganosiloxane (II) may optionally be a mixture of a dimethylpolysiloxane with hydrogenodimethylsilyl end groups and of a polyorganosiloxane bearing at least 3 SiH (hydrogenosiloxyl) functions.

The ratio of the number of hydrogen atoms bound to the silicon in the polyorganosiloxane (II) to the total number of groups with alkenyl unsaturation of the polyorganosiloxane polymer A is generally between 0.4 and 10, preferably between 0.6 and 5.

According to a preferred embodiment, the polyorganosiloxane (II) is a polyorganohydrogenosiloxane having per molecule at least 2 hydrogen atoms bound to different silicon atoms and whose organic radicals bound to the silicon atoms are selected from the group consisting of the radicals: methyl, ethyl, phenyl and combinations thereof.

The polyaddition catalyst (III) is preferably selected from the group consisting of platinum, a platinum compound, a platinum complex and mixtures thereof. In that case, the polyaddition catalyst (III) will also be the thermal stabilizer D, thus performing a dual role of polyaddition catalyst and thermal stabilizer for improving the resistance of the silicone elastomers to degradation under the effect of temperatures above 800° C.

The polyaddition catalyst (III) for improving the resistance of the silicone elastomers to degradation under the effect of temperatures above 800° C. is selected from the group consisting of: platinum metal, a platinum compound, a platinum complex and mixtures thereof. The platinum may be in the form of:
metallic (elemental) platinum,
chloroplatinic acid (for example hexachloroplatinic acid H₂PtCl₆);
platinum complexes and organic products such as notably the complexes of platinum and vinyl-containing organosiloxanes (for example the Karstedt complex), the complexes such as those of formula (PtCl₂, olefin)₂ and H(PtCl₃, olefin) where olefin represents ethylene, propylene, butylene, cyclohexene or styrene, the complexes of platinum chloride and cyclopropane or the complexes of the platinum carbene type (such as those described for example in patent application EP1235836-A2).

In addition to the obligatory ingredients specified above, the compositions according to the present invention may optionally further contain one or more auxiliary additives f) such as notably a pigment f5) for making colored wires and cables.

For preparing the compositions according to the invention, the various ingredients are mixed intimately by means of the devices that are well known in the silicone elastomers industry, and may be incorporated in any order.

Moreover, in a second object, the invention relates to the use of the composition C according to the invention as described above for making coverings or primary insulation of the single conductors included in the constitution of electric wires or cables protected against fire.

In a third object, the invention relates to electric wires or cables that are manufactured using the polyorganosiloxane compositions according to the first object of the invention.

In the context of said use, deposition of a composition C according to the invention around each single conductor may be carried out by the usual methods, notably by extrusion techniques. The deposit thus obtained is then crosslinked by heating to lead to formation of the primary insulation of silicone elastomer. The heating time varies of course with the temperature of the material and the optional working pressure. It is generally of the order of some seconds to several minutes between 100 and 120° C. and of some seconds between 180 and 200° C. It is possible to deposit several layers jointly using tandem extrusion equipped for example with a crosshead or by co-extrusion.

The invention further relates to an electric wire or an electric cable protected against fire, comprising at least one conducting element (1) surrounded by at least one primary insulating layer (2), characterized in that said primary insulating layer (2) consists of a material obtained by hardening of said composition C according to the invention, as described above, optionally by heating providing a temperature of the material in the range from 80° C. to 250° C.

According to a preferred embodiment, the material obtained by hardening of said composition C according to the invention has a density below 1.30.

The electric wire or cable according to the invention may further comprise an outer sheath surrounding the insulated electrical conductor or conductors. This outer sheath is familiar to a person skilled in the art. It may burn completely locally and be transformed into residual ash under the effect of the high temperatures of a fire but without being a propagator of fire. The material of which the outer sheath consists may be for example a matrix polymer based on polyolefin and at least one hydrated fireproofing mineral filler notably selected from the metal hydroxides such as for example magnesium dihydroxide or aluminum trihydroxide. The outer sheath is obtained conventionally by extrusion.

According to a preferred embodiment, the electric wire or electric cable protected against fire according to the invention is characterized in that the primary insulating layer (2) is formed by depositing said composition C around the conducting element (1) by an extrusion technique and by heating so as to obtain a temperature of the material in the range from 80° C. to 250° C. until said composition C hardens.

The invention further relates to a method of manufacturing an electric wire or cable according to the invention, as described above, characterized in that it comprises the steps consisting of:
i. forming, around an electrical conductor, at least one primary insulating layer (2) that consists of a material obtained by hardening said composition C optionally by heating providing a temperature of the material in the range from 80° C. to 250° C.,
ii. optionally, assembling at least two insulated electrical conductors as obtained in step i, and
iii. optionally, extruding an outer sheath as defined above around the insulated electrical conductor or conductors from step i or ii.

The following examples are given for purposes of illustration and they are not to be regarded as limiting the scope of the invention.

### EXAMPLES

### 1) Constituents

Polyorganosiloxane A1=a polydimethylsiloxane blocked at each of its two ends with a dimethylvinylsiloxy unit, and having a viscosity of 20 million mPa·s at 25° C.;
Polyorganosiloxane A2=a poly(dimethyl)(methylvinyl)-siloxane blocked at each of its two ends with a trimethylsiloxy unit, containing 720 ppm of vinyl groups in the chain, having a viscosity of 20 million mPa·s at 25° C.;
Mineral B1=natural mixture of huntite and hydromagnesite corresponding to the commercial grade Ultracarb LH15 from MINELCO,
Mineral B2=natural mixture of huntite [(Mg₃Ca(CO₃)₄)] and hydromagnesite [Mg₅(CO₃)₄(OH)₂.4H₂O)] corresponding to the commercial grade Ultracarb® 1250 from MINELCO,
Mineral species I1=wollastonite
Mineral species I2=magnesium carbonate, product from the Luvomag® range (series C013, sold by the company Lehmanns Voss & Co).
Stabilizer D1: solution, in divinyltetramethyldisiloxane, of a platinum complex at 10 wt % of platinum linked by divinyltetramethyldisiloxane (Karstedt complex);
Hardening component E1=2,4-dichlorobenzoyl peroxide;
Refractory filler G′1: pyrogenic silica (specific surface area 150 m²/g)
Refractory filler G′2: pyrogenic silica surface-treated with octamethyltetrasiloxane
Refractory filler G′3=crystalline silica (Sikron® E600 marketed by the company SIBELCO);
Refractory filler G′4=talc (MISTRON® HAR marketed by the company Imerys Talc);
Refractory filler G′5=talc (MISTRON® R10 marketed by the company Imerys Talc);
Refractory filler G′6=mica (Concord® grade 325);
Refractory filler G7=mica (Mica MAS 10®);
Refractory filler G′8=MgO (Luvomag® N 050 marketed by the company Lehmann & Voss & Co.);
Refractory filler G′9=treated kaolin (Burgess® 2211 marketed by the Company® Burgess Pigment Co.);
Refractory filler G′10=CaO (Caloxol® PG marketed by the company Omya UK Chemicals);
Refractory filler G′11=TiO₂ (Aeroxide® TIO2 P 25 marketed by the company Evonik);
MEMO: γ-methacryloxypropyltrimethoxysilane;
Additive 1=Rhodorsil® RP 110 ST (di(hydroxydimethylsiloxy) polydimethylsiloxane oil marketed by the company Bluestar Silicones France SAS);
Additive 2=RG 150 HTS (phenylated silicone oil marketed by the company Bluestar Silicones France SAS);
Additive 3=RP130 Vi (hydroxylated vinyl-containing silicone oil marketed by the company Bluestar Silicones France SAS),
Additive J1=iron ethyl-2-hexanoate.

### 2) Preparation of the Compositions

In a Z-arm kneader, the constituents of the compositions (except the hardening component) are mixed for 1 hour at room temperature (23° C.). The mixture thus obtained is then processed in a cylinder mixer and the hardening component is added to it. The compositions tested are described in Table 1 below.

The ease of use (or “processability”) of the mixture was evaluated in the cylindrical mixer. The mixture is evaluated according to the following scale:

0=mixture very sticky, unsuitable for working on cylinders;

1-2=sticky, the mixture is difficult to use on cylinders;

3-4=slightly sticky;

5=not sticky, the mixture is easy to use on cylinders.

TABLE 1
Constituents of the compositions

| | Compositions calculated as percentage by weight relative to | | | | | | |
|---|---|---|---|---|---|---|---|
| | the sum of the polyorganosiloxanes A1 and A2 | | | | | | |
| Constituents | C-1 | C-2 | C-3 | I-1 | I-2 | I-3 | I-4 |
| Polyorganosiloxane A2 | 98.54 | 33.87 | 100 | 25.73 | 25.73 | 100 | 100 |
| Polyorganosiloxane A1 | 1.46 | 66.13 | | 74.27 | 74.27 | | |
| Mineral B1 | | | | 4.50 | 4.50 | 22.33 | 11.17 |
| Mineral B2 | | | | | | | 11.17 |
| Mineral species I1 | | 3.33 | | | | | |
| Thermal stabilizer D1 | 12 ppm | 20 ppm | 20 ppm | 5 ppm | 5 ppm | 20 ppm | 20 ppm |
| (amount of platinum in | | | | | | | |
| ppm relative to the total | | | | | | | |
| weight of the composition) | | | | | | | |
| Refractory filler G′1 | 13.65 | 12.56 | | 42.76 | 42.76 | | |
| Refractory filler G′2 | | 18.38 | 24 | | | 24 | 24 |
| Refractory filler G′3 | | 33.30 | 96 | | | 96 | 96 |
| Refractory filler G′4 | | | | | 12.01 | | |
| Refractory filler G′5 | | | | 12.02 | 6.00 | | |
| Refractory filler G′6 | 7.71 | | | | | | |
| Refractory filler G′7 | 0.80 | 1.78 | | | | | |
| Refractory filler G′8 | | | | 3.01 | 3.00 | | |
| Refractory filler G′9 | | 26.64 | | | | | |
| Refractory filler G′10 | | 0.29 | | | | | |
| Refractory filler G′11 | 1.68 | 2.01 | | | | | |
| MEMO | 0.69 | | 0.4 | 0.46 | 0.46 | 0.4 | 0.4 |
| Zinc oxide H1 | 4.40 | 4.93 | | 4.50 | 4.50 | | |
| Cerium hydroxide | 0.87 | 1.95 | | | | | |
| Additive J1 | 0.63 | 0.39 | 0.4 | | | 0.4 | 0.4 |
| Additive 1 | 4.36 | 2.90 | 1.0 | 3.93 | 3.93 | 1 | 1 |
| Additive 2 | | | | 3.02 | 3.02 | | |
| Additive 3 RP130 Vi | | 1.94 | | | | | |
| Hardening component E1 | 1.48 | 2.00 | 1.5 | 2.62 | 2.62 | 1.50 | 1.50 |

### 3) Characterization of the Compositions

(1i) A fraction of the homogeneous paste obtained in the kneader is used for measuring the mechanical properties of the silicone elastomer resulting from the hot vulcanization of the polyorganosiloxane composition. For this, the fraction of homogeneous paste employed for this purpose is then vulcanized, under pressure, for 8 minutes at 115° C., working in a suitable mold for producing plates with a thickness of 2 mm. Plates are thus obtained in the unannealed (UA) state. Then a fraction of the plates is annealed for 4 h at 200° C. (A) and then aged for 10 days at 200° C. Then standardized specimens are taken from all of these plates and the following properties are measured:
Shore hardness A (SHA) according to standard DIN 53505,
breaking strength (BS) in MPa according to standard AFNOR NF T 46002,
elongation at break (EB) in % according to the preceding standard,
elastic modulus (Mod 100%) at 100% elongation in MPa according to the preceding standard.

The density of the silicone elastomer in the unannealed state (UA) is also measured, working according to the instructions in standard AFNOR NF T 46030.

(2i) Another fraction of the homogeneous paste obtained in the kneader is cut into strips to feed the extruder for making an electric cable. Manufacture of the cable is of standard construction consisting of making a cable with diameter of 2.8 mm comprising a single copper conductor with diameter of 1.05 mm, around which a covering or primary insulation of silicone elastomer having a thickness of 0.875 mm is extruded. The cable thus obtained at extruder outlet is vulcanized in an infrared hot-air stove at a temperature of the order of 250° C. (providing a temperature of the material of the order of 110-130° C.) for 1 to 3 minutes. Then standardized specimens are taken from the cable for measuring the cohesion of the ash under a voltage of 500 volts according to standard NF C 32-070 CR1. The results obtained are reported in Table 2 below. The term “NC” signifies that the test was not conclusive and it is qualified as “not classified” (NC).

TABLE 2
Mechanical properties and cohesion of the ash.

| | Compo- | Compo- | Compo- | Compo- |
|---|---|---|---|---|
| | sition | sition | sition | sition |
| | C-1 | C-2 | I-1 | I-2 |
| Density of the | 1.23 | 1.42 | 1.26 | 1.28 |
| silicone elastomer | | | | |
| in the unannealed | | | | |
| state (UA) | | | | |

Mechanical properties of the silicone elastomer in the
unannealed state (UA)

| | | | | |
|---|---|---|---|---|
| SHA (Pt) | 75 | 62 | 71 | 71 |
| BS (MPa) | 8 | 6.8 | 8.5 | 8.1 |
| EB (%) | 240 | 406 | 331 | 324 |
| Mod 100% | | | 3.4 | 3.7 |
| Ease of use (or | 4 | 4 | 5 | 5 |
| “processability”) | | | | |

Mechanical properties after thermal aging for 10 days at 200° C.

| | | | | |
|---|---|---|---|---|
| SHA (Pt) | 79 | 70 | 84 | 85 |
| BS (MPa) | 7.2 | 6.7 | 6.1 | 6.0 |
| EB (%) | 140 | 143 | 190 | 172 |

Cohesion of the ash at 500 V according to standard NFC 32070 CR1

| | | | | |
|---|---|---|---|---|
| Time in minutes | NC | 70 | >90 | >90 |

(3i) The flame resistance tests of the elastomers obtained are carried out according to international standard IEC 60707 defined by the Underwriters Laboratories. More precisely, the protocol used for evaluating the compositions presented in Table 1 corresponds to standard UL 94V, which consists of exposing vertically to the flame, a test specimen of vulcanized elastomer 127 mm long, 12.7 mm wide and with thickness stated in the tests hereunder. Thus, this test specimen undergoes two successive exposures, each of 10 seconds, to a flame of about 900° C. calibrated according to the requirements of the aforementioned standard. The extinction times T1 and then T2 are recorded for each exposure.

Classification is thus carried out:
classification “V0” is the best, this classification corresponding to a material that is difficultly flammable, and does not produce burning drops during the test;
for the classification “V1”, the material is more easily flammable but does not produce burning drops during the test;
for the classification “V2”, in addition to flammability being easier than for V0, burning drops may be produced during the test;
materials that are even more flammable are given the value “NC” (not classified). The results obtained are reported in Table 3 below.

TABLE 3

| | | |
|---|---|---|
| Composition | Composition | Composition |
| C-3 | I-3 | I-4 |

Flame resistance tests (UL94V)

| | | | |
|---|---|---|---|
| Classification | NC | V0 | V0 |
| Test specimen thickness = | | | |
| 3 mm; elastomer annealed | | | |
| Classification | NC | V0 | V0-V1 |
| Test specimen thickness = | | | |
| 2 mm; elastomer annealed | | | |
| Classification | NC | V1 | V1 |
| Test specimen thickness = | | | |
| 2 mm; elastomer not annealed | | | |

The compositions according to the invention display better performance of self-extinguishability or flame resistance when they are hardened with elastomers.

It should be noted that a comparative composition was tested with a mineral species I2=magnesium carbonate, a product from the Luvomag® range (series C013, sold by the company Lehmanns Voss & Co), but the results were not satisfactory and were qualified as “not classified” (NC).

1. A composition C comprising:
(A) per 100 parts by weight of at least one polyorganosiloxane polymer A having per molecule at least two C₂-C₆ alkenyl groups bound to the silicon,
(B) from 0.1 to 250 parts by weight of at least one mineral B selected from the group consisting of: hydromagnesite of empirical formula Mg₅(CO₃)₄(OH)₂.4H₂O, huntite of empirical formula Mg₃Ca(CO₃)₄ and mixtures thereof,
(C) from 0 to 0.02 part by weight, or from 0 ppm to 200 ppm, and optionally from 0.00001 to 0.02 part by weight, or from 0.1 ppm to 200 ppm, expressed as weight of elemental platinum metal relative to the total weight of the composition C, of at least one thermal stabilizer D for improving the resistance of the silicone elastomers to degradation under the effect of temperatures above 800° C. and that is selected from the group consisting of: platinum metal, a platinum compound, a platinum complex and mixtures thereof, and
(D) a hardening component E in a sufficient amount for hardening the composition.

2. The composition C as claimed in claim 1 comprising:
(A) per 100 parts by weight of at least one polyorganosiloxane polymer A having per molecule at least two C₂-C₆ alkenyl groups bound to the silicon,
(B) from 0.5 to 250 parts by weight of at least one mineral B selected from the group consisting of: hydromagnesite of empirical formula Mg₅(CO₃)₄(OH)₂.4H₂O, huntite of empirical formula Mg₃Ca(CO₃)₄ and mixtures thereof,
(C) from 0.00001 to 0.02 part by weight, or from 0.1 ppm to 200 ppm, expressed as weight of elemental platinum metal relative to the total weight of the composition C, of at least one thermal stabilizer D for improving the resistance of the silicone elastomers to degradation under the effect of temperatures above 800° C. and that is selected from the group consisting of: platinum metal, a platinum compound, a platinum complex and mixtures thereof,
(D) a hardening component E in a sufficient amount for hardening the composition,
(E) from 0 to 200 parts by weight, optionally from 0.5 to 120 parts by weight and optionally from 0.5 to 50 parts by weight of at least one fusible filler F having a softening point between 300° C. and 900° C.,
(F) from 0 to 250 parts by weight and optionally from 0.1 to 100 parts by weight and optionally from 0.5 to 50 parts by weight of at least one refractory mineral filler G,
(G) from 0 to 300 parts by weight, optionally from 1 to 100 parts by weight and optionally from 1 to 80 parts by weight of at least one fireproofing mineral filler H selected from the group consisting of: magnesium hydroxide Mg(OH)₂, aluminum hydroxide Al(OH)₃ that has optionally been surface-treated with an organoalkoxysilane or an organosilazane, and mixtures thereof, and
(H) from 0 to 20 parts by weight, optionally from 0.1 to 15 parts by weight and optionally from 0.5 to 10 parts by weight of a zinc oxide.

3. The composition C as claimed in claim 1, wherein the hardening component E is:
at least one organic peroxide (a-1), or
a component (a-2) consisting of:
a) at least one polyorganosiloxane (II) having, per molecule, at least two hydrogen atoms bound to the silicon, and optionally at least three hydrogen atoms bound to the silicon, and
b) an effective amount of at least one polyaddition catalyst (III), optionally selected from the group consisting of platinum, a platinum compound, a platinum complex and mixtures thereof.

4. The composition C as claimed in claim 1, comprising from 0.00001 to 0.0009 part, or from 0.1 ppm to 9 ppm, expressed as weight of elemental platinum metal relative to the total weight of the composition C and of at least one thermal stabilizer D for improving the resistance of the silicone elastomers to degradation under the effect of temperatures above 800° C. and that is selected from the group consisting of: platinum metal, a platinum compound, a platinum complex and mixtures thereof.

5. The composition C as claimed in claim 2 in which the fusible filler F is selected from the group consisting of: boron oxide, zinc borates, boron phosphates, ground glasses, glasses in the form of beads, calcium borates and mixtures thereof.

6. The composition C as claimed in claim 2 in which the refractory mineral filler G is selected from the group consisting of: magnesium oxides, calcium oxides, silica, quartz, montmorillonites, talcs, kaolins, micas and mixtures thereof.

7. The composition C as claimed in claim 1 in which the polyorganosiloxane polymer A has, per molecule, at least 2 vinyl groups bound to different silicon atoms, situated in the chain, at chain ends or in the chain and at chain ends, and whose other organic radicals bound to the silicon atoms are selected from the group consisting of the radicals: methyl, ethyl and phenyl.

8. The composition C as claimed in claim 3 in which the polyorganosiloxane (II) is a polyorganohydrogenosiloxane having per molecule at least 2 hydrogen atoms bound to different silicon atoms and whose organic radicals bound to the silicon atoms are selected from the group consisting of the radicals: methyl, ethyl, phenyl and combinations thereof.

9. A composition C as described in claim 1, capable of being used for making coverings or primary insulation of the single conductors included in the constitution of electric wires or cables protected against fire.

10. An electric wire or electric cable protected against fire comprising at least one conducting element surrounded by at least one primary insulating layer, wherein said primary insulating layer comprises or consists of a material obtained by hardening of said composition C as defined in claim 1 optionally by heating providing a temperature of the material in the range from 80° C. to 250° C.

11. The electric wire or electric cable protected against fire as claimed in claim 10, wherein the primary insulating layer is formed by depositing said composition C around the conducting element by an extrusion technique and by heating so as to obtain a temperature of the material in the range from 80° C. to 250° C. until said composition C has hardened.

12. A method for manufacturing an electric wire or cable as described in claim 10, comprising or consisting of:
i. forming, around an electrical conductor, at least one primary insulating layer that consists of a material obtained by hardening said composition C as defined in claim 1 optionally by heating providing a temperature of the material in the range from 80° C. to 250° C.,
ii. optionally, assembling at least two insulated electrical conductors as obtained in step i, and
iii. optionally, extruding an outer sheath as defined above around the insulated electrical conductor or conductors from step i or ii.
